(19) United States
(12) Patent Application Publication
(10) Pub. No.: US 2025/0116294 A1
(43) Pub. Date: Apr. 10, 2025

(54) AERODYNAMIC BEARING

(71) Applicant: Dyson Technology Limited, Malmesbury, Wiltshire (GB)

(72) Inventors: Roberto FAVENTI, Malmesbury (GB); Niall Alexander TSIVANIDIS, London (GB); Alexander Thomas WELLS, Gloucester (GB)

(21) Appl. No.: 18/836,189

(22) PCT Filed: Jan. 30, 2023
(86) PCT No.: PCT/GB2023/050206

§ 371 Date: Aug. 6, 2024

(30) Foreign Application Priority Data
Feb. 11, 2022 (GB) 2201794.1

(51) Int. Cl. F16C 17/02; H02K 7/08

(52) U.S. Cl. CPC F16C 17/024; F16C 2208/10; F16C 2314/00; F16C 2380/26; H02K 7/08

(57) ABSTRACT

An aerodynamic bearing has an inner surface defining a channel for receiving a shaft. The inner surface is deformable between a first position in which the inner surface is located at a first radial distance, and a second position in which the inner surface is located at a second radial distance. The second radial distance is greater than the first radial distance. The inner surface is formed of at least one of an elastomeric material and a plastic material.

### FIELD OF THE INVENTION

The present invention relates to an aerodynamic bearing, a rotor assembly comprising an aerodynamic bearing, and a brushless motor comprising such a rotor assembly.

### BACKGROUND OF THE INVENTION

There is a general desire to improve brushless motors, such as brushless motors found in vacuum cleaners, in a number of ways. In particular, improvements may be desired in terms of size, weight, manufacturing cost, performance, efficiency, reliability and noise.

Rolling bearings may be limited in that relatively high rotational speeds result in a shorter lifespan, and may generate heat as a result of friction, which can result in limitations for brushless motors that utilise rolling bearings.

### SUMMARY OF THE INVENTION

According to a first aspect of the present invention there is provided an aerodynamic bearing comprising an inner surface defining a channel for receiving a shaft, the inner surface deformable between a first position in which the inner surface is located at a first radial distance, and a second position in which the inner surface is located at a second radial distance, the second radial distance greater than the first radial distance, wherein the inner surface is formed of at least one of an elastomeric material and a plastic material.

The aerodynamic bearing may be beneficial as forming the inner surface of at least one of an elastomeric material and a plastic material may allow for increased flexibility of manufacturing compared to, for example, a foil air bearing, and in particular may enable use of mass manufacturing techniques, for example such as extrusion or injection moulding, whilst still providing the inner surface with the flexibility to deform between the first and second positions. An aerodynamic bearing may enable higher rotational speeds of the shaft compared to, for example, a rolling bearing. Use of at least one of an elastomeric material and a plastic material may also allow for reduced tolerance stacks and decreased component count relative to, for example, conventional foil air bearings.

It will be appreciated that some plastic materials may also be considered elastomeric materials, and vice versa.

The inner surface may be deformable from the first position to the second position upon rotation of the shaft within the channel in use, for example rotation of the shaft within the channel at a speed in excess of a speed threshold in use. The speed threshold may comprise at least 10 krpm, at least 20 krpm, at least 30 krpm, at least 40 krpm, or at least 50 krpm. The first position may comprise a position at which the inner surface is in contact with, or immediately adjacent to, a shaft located within the channel in use, for example such that the first position comprises a position of minimal radial distance of the inner surface when a shaft is located within the channel in use. The second position may comprise a position of maximal radial distance of the inner surface when a shaft is located within the channel in use.

The aerodynamic bearing may comprise a support member disposed radially outwardly of the inner surface, the support member formed of the at least one of the elastomeric material and the plastic material. Use of a support member may facilitate deformation of the inner surface between the first and second positions in a controlled manner. For example, the support member may ensure sufficient stiffness of the inner surface to hold a shaft within the channel when the inner surface is in the first position, whilst also allowing for deformation of the inner surface from the first position to the second position.

By forming the support member from the at least one of the elastomeric material and the plastic material, the support member and the inner surface may be formed as part of the same manufacturing process, thereby reducing component count, and hence reducing risk of component failure, and thereby reducing component cost. The inner surface and the support member may be integrally formed, for example such that the aerodynamic bearing comprises a monolithic component.

The support member may comprise a plurality of arcuate ribs defining apertures, for example spaced apart about a periphery of the inner surface. Use of such arcuate ribs defining apertures may facilitate controlled deformation of the inner surface whilst minimising material usage, and hence minimising weight and cost of the aerodynamic bearing. A number of the plurality of arcuate ribs and/or apertures may be chosen to be tailored to a desired stiffness of the aerodynamic bearing across a desired displacement range, which may in turn be determined by a desired rotational speed of a shaft within the channel in use.

The aerodynamic bearing may comprise an outer surface spaced from the inner surface, and the support member may be disposed between the inner surface and the outer surface. Use of such an arrangement may facilitate insertion of the aerodynamic bearing into a frame, and/or may ensure structural integrity of the aerodynamic bearing whilst enabling controlled deformation of the inner surface in use. The outer surface may be formed of the at least one of the elastomeric material and the plastic material. The inner surface and the outer surface, and/or the outer surface and the support member, may be integrally formed, for example such that the aerodynamic bearing comprises a monolithic component.

The inner surface may be continuous in form, for example such that the inner surface defines an annular wall of the channel. Such a continuous inner surface may enable relatively uniform stiffness about a periphery of the inner surface, such that relatively even deformation of the inner surface is experienced about the periphery of the channel in use, and may inhibit pressure leakage from the channel when a shaft rotates within the channel in use. The inner surface may be smooth in form, for example such that the inner surface is substantially free of any projections and/or recesses.

The support member may be annular in form, and may define an outer surface of the aerodynamic bearing. The inner surface may be cantilevered relative to the support member, for example with the inner surface extending radially inwardly from the support member. This may facilitate deformation of the inner surface relative to the support member without the need for any intervening components therebetween.

The inner surface may comprise a plurality of discrete inner surfaces defining the channel. This may facilitate manufacture of the aerodynamic bearing using, for example, an injection moulding manufacturing process.

The aerodynamic bearing may be formed by an extrusion process. An extrusion process may be particularly suited to mass manufacturing.

The aerodynamic bearing may be formed by an injection moulding process. An injection moulding process may be particularly suited to mass manufacturing.

The inner surface may comprise a low friction coating, for example a coating that provides lower frictional effects than that provided by the at least one of the elastomeric material and the plastic material alone. This may facilitate rotation of airflow between the inner surface and a shaft disposed within the channel in use. The low friction coating may comprise any of a diamond-like-coating or a Teflon coating.

According to a second aspect of the present invention there is provided an aerodynamic bearing comprising an inner surface defining a channel for receiving a shaft, the inner surface deformable between a first position in which the inner surface is located at a first radial distance, and a second position in which the inner surface is located at a second radial distance, the second radial distance greater than the first radial distance, wherein the inner surface is continuous in form such that the inner surface annularly defines the channel.

According to a third aspect of the present invention there is provided an aerodynamic bearing comprising an inner surface defining a channel for receiving a shaft, and a support member from which the inner surface depends, the inner surface deformable between a first position in which the inner surface is located at a first radial distance, and a second position in which the inner surface is located at a second radial distance, the second radial distance greater than the first radial distance, wherein the inner surface and the support member are integrally formed.

According to a fourth aspect of the present invention there is provided a rotor assembly for a brushless motor, the rotor assembly comprising an aerodynamic bearing according to the first, second, or third aspects of the present invention, and a shaft located within the channel.

According to a fifth aspect of the present invention there is provided a brushless motor comprising a rotor assembly according to the fourth aspect of the present invention.

The brushless motor may comprise a frame for supporting the shaft, and the aerodynamic bearing may be integrally formed with the frame. This may reduce component count and cost, and may result in a reduced risk of component failure, relative to, for example a brushless motor where a separate bearing assembly is attached to a frame.

According to a sixth aspect of the present invention there is provided brushless motor comprising a rotor assembly comprising a shaft, a frame, and an aerodynamic bearing integrally formed with the frame, the aerodynamic bearing configured to support the shaft within the frame.

According to a seventh aspect of the present invention there is provided a vacuum cleaner comprising a brushless motor according to the fifth or sixth aspects of the present invention.

According to an eighth aspect of the present invention there is provided a haircare appliance comprising a brushless motor according to the fifth or sixth aspects of the present invention.

Preferential features of aspects of the present invention may be equally applied to other aspects of the present invention, where appropriate.

### BRIEF DESCRIPTION OF THE DRAWINGS

FIG. 1 is a schematic view of a first embodiment of an aerodynamic bearing;

FIG. 2 is a schematic view of the aerodynamic bearing of FIG. 1 in a first use condition;

FIG. 3 is a schematic view of the aerodynamic bearing of FIG. 1 in a second use condition;

FIG. 4 is a schematic view of a second embodiment of an aerodynamic bearing;

FIG. 5 is a schematic view of a rotor assembly incorporating the aerodynamic bearing of FIG. 1 or the aerodynamic bearing of FIG. 4;

FIG. 6 is a schematic exploded view of a brushless permanent magnet motor incorporating the rotor assembly of FIG. 5;

FIG. 7 is a schematic view of a vacuum cleaner incorporating the brushless permanent magnet motor of FIG. 6; and

FIG. 8 is a schematic view of a haircare appliance incorporating the brushless permanent magnet motor of FIG. 6.

### DETAILED DESCRIPTION OF THE INVENTION

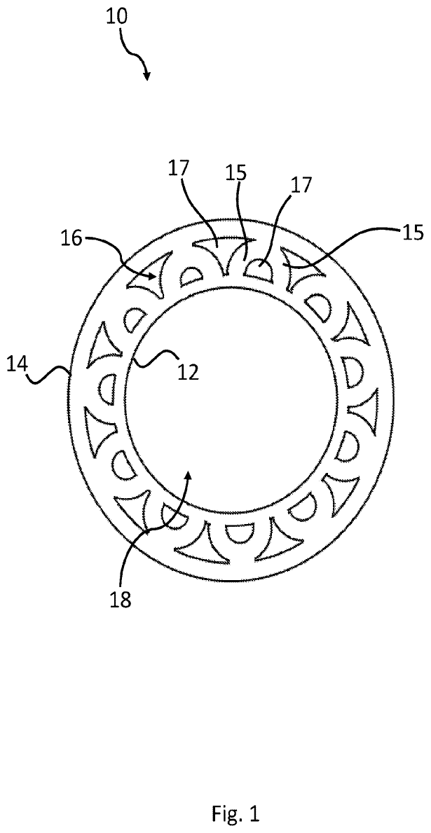

A first embodiment of an aerodynamic bearing 10 is illustrated schematically in FIG. 1.

The aerodynamic bearing 10 comprises an inner surface 12, an outer surface 14, and a support member 16 located between the inner surface 12 and the outer surface 14. The inner surface 12 is substantially continuous, smooth, and annular in form. The inner surface 12 defines a channel 18 for receiving a shaft of a rotor assembly of a brushless permanent magnet motor in use. The inner surface 12 is provided with a low friction coating, such as a diamond-like coating or Teflon. The outer surface 14 is radially spaced from the inner surface 12, and is substantially continuous, smooth, and annular in form.

The support member 16 comprises a plurality of arcuate ribs 15 located between the inner surface 12 and the outer surface 14, with the ribs 15 defining apertures 17. It will be appreciated that the number and form of the ribs 15, and indeed the form of the support member 16, can vary depending on a desired isotropic stiffness of the aerodynamic bearing 10.

The inner surface 12, the outer surface 14, and the support member 16 are integrally formed of an elastomeric material, or a plastic material, as part of the same manufacturing process. In such a manner the aerodynamic bearing 10 can be considered to be a monolithic component. Examples of appropriate elastomeric or plastic materials include natural rubber, Nitrile NBR, silicone, polyurethane, PEEK, PBT, PC, ABS, and PA. The aerodynamic bearing 10 can be formed by one of an extrusion process, an injection moulding process, or an additive manufacturing process.

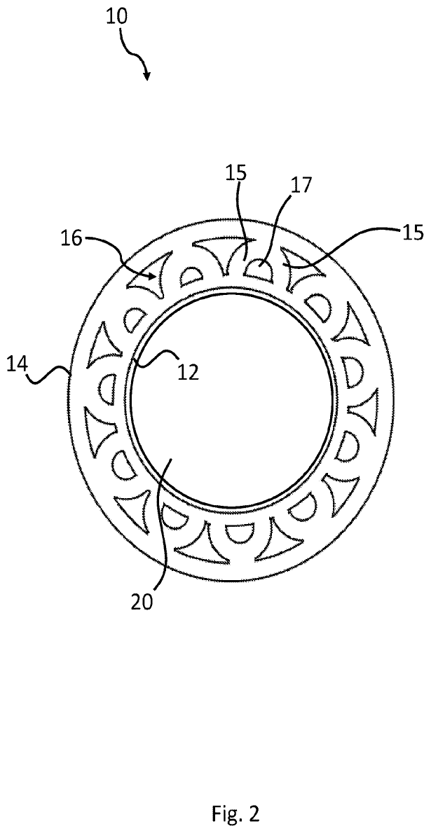

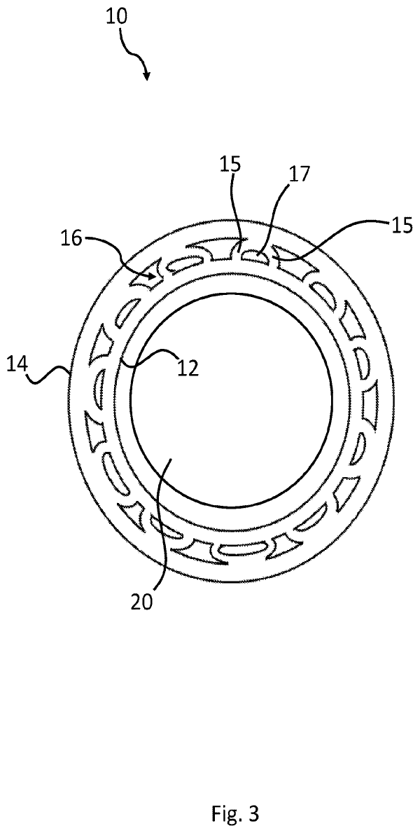

In use, a shaft 20 of a brushless permanent magnet motor is located within the channel 18 such that the inner surface 12 of the aerodynamic bearing 10 is at a first position in contact with the shaft 20. This is illustrated schematically in FIG. 2, with a slight gap shown between the inner surface 12 and the shaft 20 such that the separate components can be identified. The wall thickness of the inner surface 12 and the outer surface 14, the elastomeric material/plastic material, and the form of the support member 16, are chosen to give the aerodynamic bearing a desired quasi-static isotropic radial stiffness. When the shaft 20 is driven to rotate within the channel 18 at speeds above a pre-determined threshold, for example speeds above 20-30 krpm, the inner surface 12 deforms from the first position to a second position, illustrated schematically in FIG. 3, in which the inner surface 12 is spaced radially from the shaft 20. A film of pressurised air is established between the inner surface 12 and the shaft 20, which enables the shaft 20 to rotate within the channel 18.

As the inner surface 12 is substantially continuous and smooth in form, radial pressure leakage from within the channel in use may be minimised, and relatively uniform deformation of the inner surface 12 about its periphery may be achieved. By forming the inner surface 12 of the elastomeric material or plastic material, flexibility of the inner surface 12 to enable deformation may be provided, whilst also enabling use of desirable mass manufacturing techniques. For example, extrusion, injection moulding, or additive manufacturing can be used to form the aerodynamic bearing 10 from the elastomeric material or the plastic material, with such processes lending themselves to mass manufacturing. Integrally forming the inner surface 12, the outer surface 14, and the support member 16 from the elastomeric material or the plastic material may further reduce component count, and hence reduce risk of component failure, and may reduce component cost, for example relative to a foil air bearing. Furthermore, integrally forming the inner surface 12, the outer surface 14, and the support member 16 from the elastomeric material or the plastic material may reduce a tolerance stack relative to, for example, a foil air bearing formed of multiple component parts joined together.

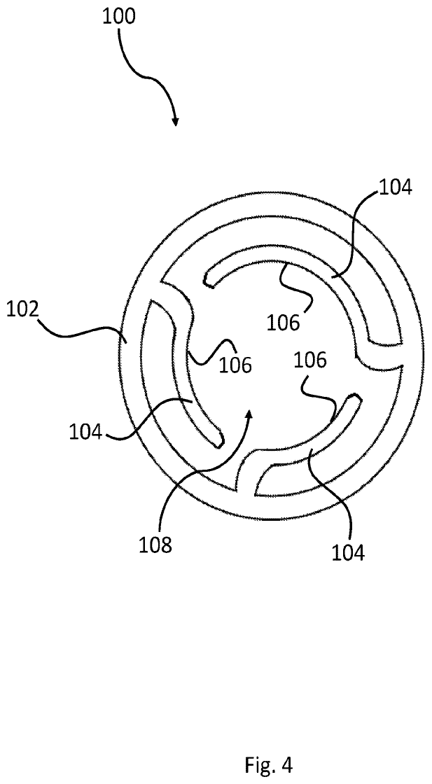

A second embodiment of an aerodynamic bearing 100 is illustrated schematically in FIG. 4.

The aerodynamic bearing comprises a support member 102, and three arms 104 cantilevered from the support member 102. Although illustrated with three arms 104, it will be appreciated that greater or fewer arms may be utilised in practice. The support member 102 is generally circular in form, and defines an outer surface of the aerodynamic bearing 100. The three arms 104 are each extend generally radially inwardly from the support member 102, before curving to follow the curvature of the support member 102, albeit spaced radially inwardly of the support member 102. Each of the three arms 104 comprises an inner surface 106, with the inner surfaces collectively defining a channel 108 for receiving a shaft of a brushless permanent magnet motor.

As seen in FIG. 4, the inner surfaces 106 of the three arms 104 are discrete surfaces that are spaced apart from one another, such that the boundary of the channel is discontinuous in form.

The support member 102 and the three arms 104 are integrally formed of an elastomeric material or a plastic material, as part of the same manufacturing process. In such a manner the aerodynamic bearing 100 can be considered to be a monolithic component. Examples of appropriate elastomeric materials or plastic materials include natural rubber, Nitrile NBR, silicone, polyurethane, PEEK, PBT, PC, ABS, and PA. The aerodynamic bearing 100 can be formed by one of an extrusion process, an injection moulding process, or an additive manufacturing process.

In use, a shaft of a brushless permanent magnet motor is located within the channel 108 such that the inner surfaces 106 of the aerodynamic bearing 100 are at a first position in contact with the shaft 20. The wall thickness of the three arms 104 and the elastomeric material or plastic material are chosen to give the aerodynamic bearing 100 a desired quasi-static isotropic radial stiffness. When the shaft is driven to rotate within the channel 108 at speeds above a pre-determined threshold, for example speeds above 20-30 krpm, the arms 104, and hence the inner surfaces, 106 deform from their first positions to respective second positions in which the inner surfaces 106 are spaced radially from the shaft. A film of pressurised air is established between the inner surfaces 106 and the shaft, which enables the shaft to rotate within the channel 108.

By forming the three arms 104, and hence the inner surfaces 106, of the elastomeric material or plastic material, flexibility of the inner surfaces 106 to enable deformation may be provided, whilst also enabling use of desirable mass manufacturing techniques. For example, extrusion, injection moulding, or additive manufacturing can be used to form the aerodynamic bearing 100 from the elastomeric material or the plastic material, with such processes lending themselves to mass manufacturing. Integrally forming the support member 102 and the three arms 104 from the elastomeric material or the plastic material may further reduce component count, and hence reduce risk of component failure, and may reduce component cost, for example relative to a foil air bearing. Furthermore, integrally forming the support member 102 and the three arms 104 from the elastomeric material or the plastic material may reduce a tolerance stack relative to, for example, a foil air bearing formed of multiple component parts joined together.

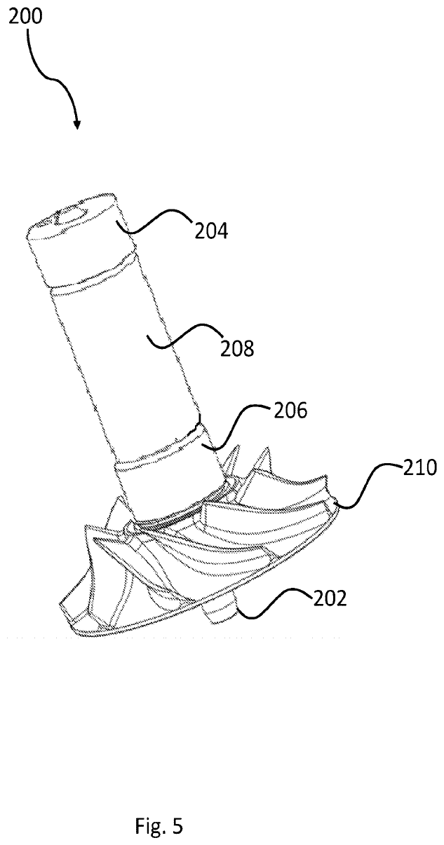

A rotor assembly 200 for a brushless permanent magnet motor is illustrated schematically in FIG. 5. Although a particular form of rotor assembly is described here, it will be appreciated that the aerodynamic bearings 10,100 described herein may find utility with other forms of rotor assembly in practice.

The rotor assembly comprises a shaft 202, first 204 and second 206 aerodynamic bearings supporting the shaft 202, a permanent magnet 208, and an impeller 210. The first 204 and second 206 aerodynamic bearings can take the form of either of the aerodynamic bearing 10 of the first embodiment, or the aerodynamic bearing 100 of the second embodiment. By using the aerodynamic bearings 10,100 discussed above, relatively high speeds of shaft rotation may be obtained compared to, for example, speeds obtainable via use of a rolling bearing.

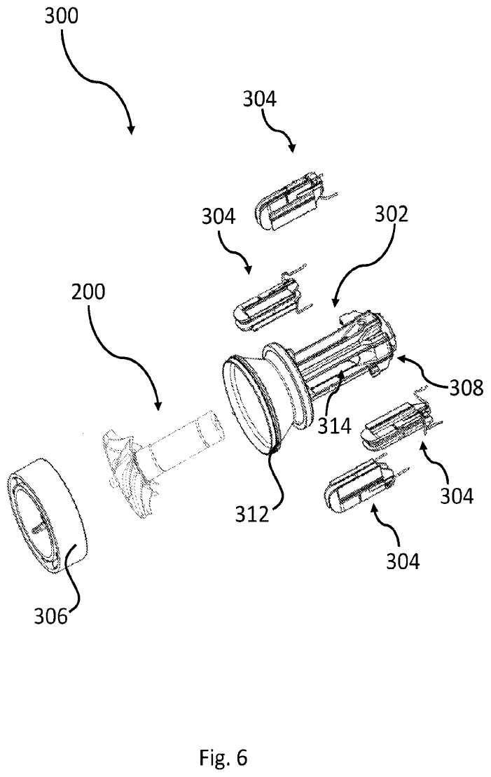

A brushless permanent magnet motor 300 incorporating the rotor assembly 200 is illustrated schematically in FIG. 6. Although a particular form of motor is described here, it will be appreciated that the aerodynamic bearings 10,100 described herein may find utility in other motors too.

The brushless permanent magnet motor 300 comprises a frame 302, four stator core assemblies 304, the rotor assembly 200, and a diffuser 306. Control circuitry of the motor 300 is not shown here for clarity.

The frame 302 has a generally cylindrical portion with first 308 and second (not shown) bearing seats, and a shroud 312. The frame also has four slots 314, each of which receives a corresponding stator assembly 304. The rotor assembly 200 is supported within the frame 302 via interaction between the first 204 and second 206 bearings, and the respective first 308 and second bearing seats, such that the shroud 312 overlays the impeller 210. In use, current driven into windings of the stator core assemblies 304 generates a magnetic field that interacts with the rotor assembly 200 to cause the rotor assembly 200 to spin within the frame 302.

Use of the aerodynamic bearings 10,100 in such a brushless permanent magnet motor 300 may enable rotation of the impeller 210 at higher speeds for longer lifespans in comparison with an arrangement that utilises rolling bearings, which may lead to improved performance characteristics for a product in which the brushless permanent magnet motor 300 is housed in use. Use of the aerodynamic bearings 10,100 may also provide the brushless permanent magnet motor 300 with improved thermal characteristics relative to an arrangement that utilises rolling bearings.

Although not illustrated, in some examples the first 204 and/or second 206 bearings can be integrally formed with the frame 304 as part of the same manufacturing process. This may reduce component count and/or cost, and may simplify an assembly process of the brushless permanent magnet motor 300.

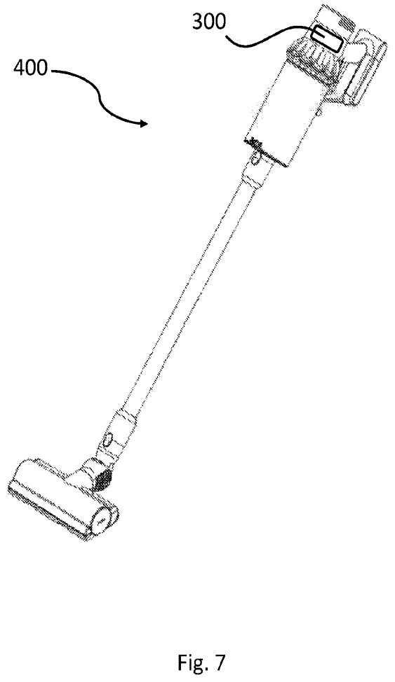

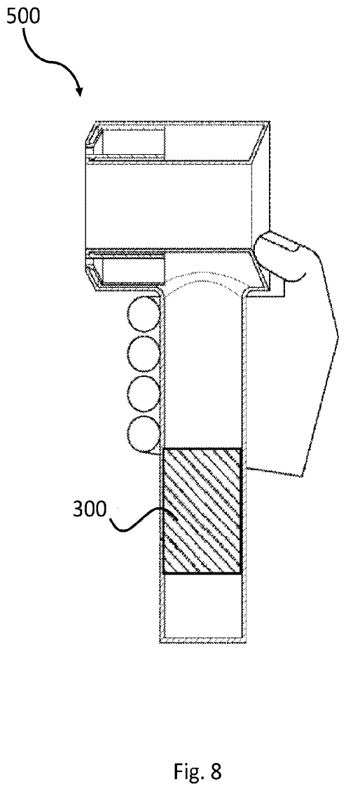

A vacuum cleaner 400 comprising the brushless permanent magnet motor 300 is illustrated schematically in FIG. 7, whilst a haircare appliance 500, in the form of a hairdryer, comprising the brushless permanent magnet motor 300 is illustrated schematically in FIG. 8. It will be appreciated that other products containing the brushless permanent magnet motor 300 are also envisaged.

1. An aerodynamic bearing comprising an inner surface defining a channel for receiving a shaft, the inner surface deformable between a first position in which the inner surface is located at a first radial distance, and a second position in which the inner surface is located at a second radial distance, the second radial distance greater than the first radial distance, wherein the inner surface is formed of at least one of an elastomeric material and a plastic material.

2. The aerodynamic bearing as claimed in claim 1, wherein the aerodynamic bearing comprises a support member disposed radially outwardly of the inner surface, the support member formed of the at least one of the elastomeric material. and the plastic material

3. The aerodynamic bearing as claimed in claim 2, wherein the inner surface and the support member are integrally formed.

4. The aerodynamic bearing as claimed in claim 2, wherein the support member comprises a plurality of arcuate ribs defining apertures.

5. The aerodynamic bearing as claimed in claim 3, wherein the aerodynamic bearing comprises an outer surface spaced from the inner surface, and the support member is disposed between the inner surface and the outer surface.

6. The aerodynamic bearing as claimed in claim 5, wherein the outer surface is formed of the at least one of the elastomeric material and the plastic material.

7. The aerodynamic bearing as claimed in claim 5, wherein the outer surface is integrally formed with the inner surface.

8. The aerodynamic bearing as claimed in claim 1, wherein the inner surface is continuous in form.

9. The aerodynamic bearing as claimed in claim 2, wherein the support member is annular in form and defines an outer surface of the aerodynamic bearing.

10. The aerodynamic bearing as claimed in claim 9, wherein the inner surface is cantilevered relative to the support member.

11. The aerodynamic bearing as claimed in claim 9, wherein the inner surface comprises a plurality of discrete inner surfaces defining the channel.

12. The aerodynamic bearing as claimed in claim 1, wherein the aerodynamic bearing is formed by an extrusion process.

13. The aerodynamic bearing as claimed in claim 1, wherein the aerodynamic bearing is formed by an injection moulding process.

14. The aerodynamic bearing as claimed in claim 1, wherein the inner surface comprises a low friction coating.

15. An aerodynamic bearing comprising an inner surface defining a channel for receiving a shaft, the inner surface deformable between a first position in which the inner surface is located at a first radial distance, and a second position in which the inner surface is located at a second radial distance, the second radial distance greater than the first radial distance, wherein the inner surface is continuous in form such that the inner surface annularly defines the channel.

16. A rotor assembly for a brushless motor, the rotor assembly comprising an aerodynamic bearing as claimed in claim 1, and a shaft located within the channel.

17. A brushless motor comprising a rotor assembly as claimed in claim 16.

18. The brushless motor as claimed in claim 17, wherein the brushless motor comprises a frame for supporting the shaft, and the aerodynamic bearing is integrally formed with the frame.

19. A vacuum cleaner comprising a brushless motor according to claim 17.

20. A haircare appliance comprising a brushless motor according to claim 17.
